(19) United States
(12) Patent Application Publication
(10) Pub. No.: US 2010/0073282 A1
(43) Pub. Date: Mar. 25, 2010

(54) ELECTROPHORETIC DISPLAY DEVICE, METHOD OF DRIVING THE SAME, AND ELECTRONIC APPARATUS

(75) Inventor: Tetsuro MURAYAMA, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/549,568

(22) Filed: Aug. 28, 2009

(30) Foreign Application Priority Data
Sep. 25, 2008 (JP) 2008-246569
May 14, 2009 (JP) 2009-117660

(51) Int. Cl. G09G 3/34

(52) U.S. Cl. 345/107

(57) ABSTRACT

An electrophoretic display device includes a pixel electrode, a common electrode, an electrophoretic element between the pixel and common electrodes, a scanning line supplying a scanning signal, a first data line supplying an image signal, a first switching element outputting the image signal, a first memory circuit maintaining the image signal, a first control line supplying a first control electric potential, a second switching element outputting the first control electric potential to the pixel electrode according to the image signal maintained in the first memory circuit, a second data line supplying an inverted image signal, a third switching element outputting the inverted image signal, a second memory circuit maintaining the inverted image signal, a second control line supplying a second control electric potential, and a fourth switching element outputting the second control electric potential to the pixel electrode according to the inverted image signal maintained in the second memory circuit.

### BACKGROUND

1. Technical Field

The present invention relates to technical fields of an electrophoretic display device, a method of driving the electrophoretic display device, and an electronic apparatus.

2. Related Art

Electrophoretic display devices of this type have a display unit that performs display by using a plurality of pixels as below. In each pixel, after an image signal is written into a memory circuit through a pixel switching element, a pixel electrode is driven based on an electric potential according to the written image signal, and an electric potential difference is generated between the pixel electrode and a common electrode. Accordingly, electrophoretic particles included in the electrophoretic element that is interposed between the pixel electrode and the common electrode are moved to the pixel electrode side or the common electrode side, and whereby the display is performed. For example, in JP-A-2003-84314, as a memory circuit for such a pixel, a configuration in which a DRAM (dynamic random access memory) is included and a configuration in which an SRAM (static random access memory) is included have been disclosed. For example, in JP-A-8-194205, an active-matrix-type display device in which a memory element that maintains a binary display signal and a switching element that turns terminals ON or OFF based on a signal that is maintained in the memory element for each pixel has been disclosed.

According to the electrophoretic display devices of this type, display is performed by the movement of the electrophoretic particles due to the electric potential difference being applied between the pixel electrode and the common electrode as described above. Accordingly, when display is shifted between an image that is currently displayed (that is, the original image) and an image to be displayed next (that is, a new image), the afterimage may be generated easily. Thus, in the electrophoretic display devices of this type, when display is shifted from the original image to the new image, a preliminary display operation, for example, for displaying an entirely black image, an entirely white image, an inverted image, or the like in the display unit for a short period of time is performed before the new image is displayed (for example, see JP-A-2007-206471). By performing such a preliminary display operation, the generation of the afterimage can be suppressed.

However, in the technology disclosed in JP-A-2003-84314, for example, an image signal relating to the entirely black image, the entirely white image, the inverted image, or the like needs to be written into the memory circuit of each pixel when the above-described preliminary display operation is performed (in other words, each time when display is shifted from the original image to the new image). Accordingly, there is a technical problem that the power consumption of the electrophoretic display device is increased.

### SUMMARY

An advantage of some aspects of the invention is that it provides an electrophoretic display device capable of displaying a high-quality image and decreasing the power consumption, a method of driving the electrophoretic display device, and an electronic apparatus that includes the electrophoretic display device.

According to a first aspect of the invention there is provided an electrophoretic display device that is formed by pinching an electrophoretic element between substrates forming one pair. The electrophoretic display device includes: a display unit that is configured by a plurality of pixels; a pixel electrode that is formed for each of the plurality of pixels; a common electrode that faces the pixel electrode through the electrophoretic element; a scanning line that supplies a scanning signal; a first data line that supplies an image signal; a first switching element that is disposed for each of the plurality of pixels and outputs the image signal, which is input from the first data line in accordance with the scanning signal; a first memory circuit that maintains the image signal output from the first switching element; a first control line that supplies a first control electric potential; a second switching element that is disposed for each of the plurality of pixels and outputs the first control electric potential input from the first control line to the pixel electrode in accordance with the image signal that is maintained in the first memory circuit; a second data line that supplies an inverted image signal that is acquired by inverting the polarity of the image signal with respect to a reference electric potential; a third switching element that is disposed for each of the plurality of pixels and outputs the inverted image signal, which is input from the second data line, in accordance with the scanning signal; a second memory circuit that maintains the inverted image signal output from the third switching element; a second control line that supplies a second control electric potential; and a fourth switching element that is disposed for each of the plurality of pixels and outputs the second control electric potential, which is input from the second control line, to the pixel electrode in accordance with the inverted image signal that is maintained in the second memory circuit.

According to the above-described electrophoretic display device, when it is operated, an image is displayed in the display unit by applying a voltage according to the image signal to the electrophoretic element of each pixel that is pinched by the substrates forming one pair between a pixel electrode that is formed for each pixel on one substrate between the substrates forming one pair that is, for example, a component substrate and, for example, a common electrode that is spread on the entire face on the other substrate of the substrates forming one pair that is, for example, an opposing substrate.

Described in more detail, inside the electrophoretic element for example, a microcapsule, as electrophoretic particles a plurality of white particles that is, for example, charged negatively and a plurality of black particles charged positively are included. In the electrophoretic element, one of the plurality of white particles charged negatively and the plurality of black particles charged positively is moved to the pixel electrode side (that is, electrophoresis) in accordance with the voltage applied between the pixel electrode and the common electrode, and the other is moved to the common electrode side in accordance with the above-described voltage. As a result, an image according to the moved electrophoretic particles is displayed on the other substrate side (that is, the common electrode side) of the substrates forming one pair.

The image signal is supplied through the first data line for each pixel. In addition, through the second data line, an inverted image signal (that is, a signal that has complementary relationship with the image signal; a signal having an electric potential acquired by inverting the electric potential of the image signal for displaying a different color tone, for example, a signal that has the low electric potential (for example, 0 V) for a case where the electric potential of the image signal is high (for example, 15 V) and has the high electric potential (for example, 15 V) for a case where the electric potential of the image signal is low (for example, 0 V)) of which the polarity is inverted with respect to the reference electric potential for each pixel is supplied. The first and second data lines are disposed so as to intersect the scanning lines that supply scanning signals, for example, on one substrate between the substrates forming one pair. A plurality of the pixel electrodes is disposed in a matrix shape, for example, in correspondence with intersections of the first and second data lines and the scanning lines.

According to an embodiment of the invention, in particular, four switching elements (that is, the first, second, third, and fourth switching elements) and two memory circuits (that is, the first and second memory circuits) are included for each pixel. The image signal supplied to the first data line is output to the first memory circuit that is, for example, is configured to include a capacitor element by the first switching element that is, for example, configured by a transistor in accordance with the time interval of the scanning signal supplied to the scanning line. Accordingly, the image signal is maintained in the first memory circuit. The second switching element outputs the first control electric potential, which is input from the first control line, to the pixel electrode in accordance with the image signal that is maintained in the first memory circuit. For example, when the electric potential of the image signal that is maintained in the first memory circuit is high, the second switching element is in the ON state, and the first control electric potential, for example, having the high electric potential is supplied to the pixel electrode from the first control line through the second switching element. On the other hand, when the electric potential of the image signal that is maintained in the first memory circuit is low, the second switching element is in the OFF state, and the first control line and the pixel electrode are electrically disconnected from each other by the second switching element. In addition, the inverted image signal that is supplied to the second data line is output to the second memory circuit that is, for example, configured to include a capacitor element in accordance with the time interval of the scanning signal supplied to the scanning line by the third switching element that is, for example, configured by a transistor. Accordingly, the inverted image signal is maintained in the second memory circuit. The fourth switching element outputs the second control electric potential, which is input from the second control line, to the pixel electrode in accordance with the inverted image signal that is maintained in the second memory circuit. For example, when the electric potential of the inverted image signal that is maintained in the second memory circuit has a high level, the fourth switching element is in the ON state, and the second control electric potential, for example, having the low electric potential is supplied to the pixel electrode from the second control line through the fourth switching element. On the other hand, when the electric potential of the inverted image signal that is maintained in the second memory circuit has the low level, the fourth switching element is in the OFF state, and the second control line and the pixel electrode are electrically disconnected from each other by the fourth switching element. Here, the inverted image signal is a signal that is acquired by inverting the polarity of the image signal with respect to the reference electric potential, the second switching element is shifted between the ON state and the OFF state in accordance with the image signal that is maintained in the first memory circuit, and the fourth switching element is shifted between the ON state and the OFF state in accordance with the inverted image signal that is maintained in the second memory circuit. Accordingly, the ON and OFF states of the second switching element and the fourth switching element are different from each other. In other words, when the second switching element is in the ON state, the fourth switching element is in the OFF state. On the other hand, when the second switching element is in the OFF state, the fourth switching element is in the ON state.

As a result, the first control electric potential, for example, having the high electric potential or the second control electric potential, for example, having the low electric potential can be supplied to the pixel electrode in accordance with the image signal.

In addition, by controlling the first control electric potential and the second control electric potential, the electric potential of the pixel electrode can be controlled such that an image relating to the preliminary display operation such as an entirely black image, an entirely white image, or an inverted image is displayed in the display unit without rewriting the image signal maintained in the first memory circuit and the inverted image signal maintained in the second memory circuit. For example, by controlling both the first and second control electric potentials to have the high electric potential, for example, the entirely black image can be displayed in the display unit. In addition, by controlling both the first and second control electric potentials to have the low electric potential, for example, the entirely white image can be displayed in the display unit. By controlling the first control electric potential to have the low electric potential and the second control electric potential to have the high electric potential, for example, the inverted image can be displayed in the display unit. Accordingly, the preliminary display operation for displaying, for example, the entirely black image, the entirely white image, the inverted image, or the like in the display unit can be performed without newly writing the image signal relating to the preliminary display operation in the first memory circuit or newly writing the inverted image signal relating to the preliminary display operation in the second memory circuit. Therefore, the afterimage can be reduced. In addition, the power consumption for the preliminary display operation can be saved, and accordingly, the power consumption of the electrophoretic display device can be reduced.

As described above, according to the above-described electrophoretic display device, a high-quality image having reduced afterimage can be displayed, and the power consumption can be reduced.

In the above-described electrophoretic display device, it may be configured that the first switching element is configured by a first transistor that has a first input terminal that is electrically connected to the first data line, a first gate electrode that is electrically connected to the scanning line, and a first output terminal, the first memory circuit is configured to include a first capacitor element that is electrically connected to the first output terminal, the second switching element is configured by a second transistor that has a second input terminal that is electrically connected to the first control line, a second gate electrode that is electrically connected to the first output terminal and the first capacitor element, and a second output terminal that is electrically connected to the pixel electrode, the third switching element is configured by a third transistor that has a third input terminal that is electrically connected to the second data line, a third gate electrode that is electrically connected to the scanning line, and a third output terminal, the second memory circuit is configured to include a second capacitor element that is electrically connected to the third output terminal, and the fourth switching element is configured by a fourth transistor that has a fourth input terminal that is electrically connected to the second control line, a fourth gate electrode that is electrically connected to the third output terminal and the second capacitor element, and a fourth output terminal that is electrically connected to the pixel electrode.

In such a case, the display unit for each pixel can be formed to have a relatively simple configuration, and accordingly, a practical advantage can be acquired.

In the above-described electrophoretic display device, it may be configured that the first, second, third, and fourth transistors are N-channel transistors.

In such a case, the first, second, third, and fourth transistors can be formed by using amorphous semiconductor in an easy manner. Accordingly, the manufacturing cost of the electrophoretic display device can be reduced, and the reliability thereof can be improved. It is relatively difficult to form the P-channel transistor by using amorphous semiconductor, compared to a case where the N-channel transistor is formed by using amorphous semiconductor.

In the above-described electrophoretic display device, it may be configured that the first, second, third, and fourth transistors are P-channel transistors.

In such a case, all the first, second, third, and fourth transistors can be formed as P-channel transistors in an easy manner. Accordingly, the manufacturing cost of the electrophoretic display device can be reduced, and the reliability thereof can be improved.

According to a second aspect of the invention, there is provided a method of driving an electrophoretic display device that is formed by pinching an electrophoretic element between substrates forming one pair and includes: a display unit that is configured by a plurality of pixels; a pixel electrode that is formed for each of the plurality of pixels; a common electrode that faces the pixel electrode through the electrophoretic element; a scanning line that supplies a scanning signal; a first data line that supplies an image signal; a first switching element that is disposed for each of the plurality of pixels and outputs the image signal, which is input from the first data line, in accordance with the scanning signal; a first memory circuit that maintains the image signal output from the first switching element; a first control line that supplies a first control electric potential; a second switching element that is disposed for each of the plurality of pixels and outputs the first control electric potential input from the first control line to the pixel electrode in accordance with the image signal that is maintained in the first memory circuit; a second data line that supplies an inverted image signal that is acquired by inverting the polarity of the image signal with respect to a reference electric potential; a third switching element that is disposed for each of the plurality of pixels and outputs the inverted image signal, which is input from the second data line in accordance with the scanning signal; a second memory circuit that maintains the inverted image signal output from the third switching element; a second control line that supplies a second control electric potential; and a fourth switching element that is disposed for each of the plurality of pixels and outputs the second control electric potential, which is input from the second control line, to the pixel electrode in accordance with the inverted image signal that is maintained in the second memory circuit. The above-described method includes: writing the image signal from the first data line into the first memory circuit through the first switching element and writing the inverted image signal from the second data line into the second memory circuit through the third switching element; and displaying an image in the display unit by applying a voltage between the pixel electrode and the common electrode by supplying the first control electric potential from the first control line to the pixel electrode through the second switching element or supplying the second control electric potential from the second control line to the pixel electrode through the fourth switching element and supplying a common electric potential to the common electrode.

The electrophoretic device can be driven appropriately according to the above-described method of driving the electrophoretic device. In particular, in displaying of the image, by controlling the first control electric potential and the second control electric potential, the electric potential of the pixel electrode can be controlled such that an image relating to the preliminary display operation such as an entirely black image, an entirely white image, or an inverted image is displayed in the display unit without rewriting the image signal maintained in the first memory circuit and the inverted image signal maintained in the second memory circuit. Therefore, the afterimage can be reduced, and the power consumption for the preliminary display operation can be saved. In other words, a high-quality image can be displayed with low power consumption.

In the above-described method of driving the electrophoretic display device, it may be configured that, in the displaying of the image, any one of a first electric potential and a second electric potential that is lower than the first electric potential is supplied as the first control electric potential to the pixel electrode through the second switching element, or any one of the first electric potential and the second electric potential is supplied as the second control electric potential to the pixel electrode through the fourth switching element, and the common electric potential is supplied such that the first electric potential and the second electric potential are repeated in each predetermined period.

In such a case, in the displaying of the image, an electric potential difference between the first electric potential and the second electric potential is repeatedly applied between the pixel electrode and the common electrode in each predetermined period. In other words, in the displaying of the image, a period in which an electric potential difference between the first electric potential and the second electric potential is applied between the pixel electrode and the common electrode and a period in which an electric potential difference between the first electric potential and the second electric potential is not applied between the pixel electrode and the common electrode are repeated. In description here, to supply the common electric potential to the common electrode such that the first electric potential and the second electric potential are supplied repeatedly is appropriately referred to as “common swing driving”. In other words, in displaying of the image, the common swing driving is performed. Accordingly, in the displaying of the image, an electric potential difference between the first electric potential and the second electric potential can be applied between the pixel electrode and the common electrode. Therefore, the electrophoretic particles located inside the electrophoretic element can be moved assuredly (in other words, the electrophoretic particles attached to the coating of the electrophoretic element that is, for example, the microcapsule can be drawn to be stripped). In addition, according to the common swing driving, the electric potential applied between the pixel electrode and the common electrode can be controlled by using high and low values. Therefore, a voltage to be applied can be lowered, and the circuit configuration can be simplified. In addition, when a thin film transistor (TFT) is used as the switching element, there is an advantage that the reliability of the TFT is improved by performing low-voltage driving.

The above-described method of driving the electrophoretic display device may further include, after displaying of the image, partially rewriting an image that is displayed in the display unit by applying a voltage between the pixel electrode and the common electrode of the pixel among the plurality of pixels into which a gray scale is to be rewritten by supplying an electric potential different from the common electric potential to one of the first control line and the second control line and not applying a voltage between the pixel electrode and the common electrode of the pixel among the plurality of pixels into which a gray scale is not to be rewritten by supplying an electric potential that is the same as the common electric potential to the other of the first control line and the second control line or having the other in a high impedance state so as to be electrically disconnected.

In such a case, the image displayed in the display unit is partially rewritten in the partially rewriting of the image (in other words, a voltage is applied between the pixel electrode and the common electrode of only pixels among the plurality of pixels in which gray scales are to be rewritten). Accordingly, the power consumption can be reduced.

According to a third aspect of the invention, there is provided an electronic apparatus including the above-described electrophoretic display device.

According to the above-described electronic apparatus, the above-described electrophoretic display device is included therein, and accordingly, various electronic apparatuses such as a wrist watch, an electronic paper sheet, an electronic notebook, a cellular phone, and a mobile audio apparatus that can perform high-quality display with low power consumption can be realized.

The operation and other advantages of the invention will be disclosed in detail below.

### BRIEF DESCRIPTION OF THE DRAWINGS

The invention will be described with reference to the accompanying drawings, wherein like numbers reference like elements.

FIG. 1 is a block diagram showing the entire configuration of an electrophoretic display device according to a first embodiment of the invention.

FIG. 2 is an equivalent circuit diagram showing the electrical configuration of a pixel of the electrophoretic display device according to the first embodiment.

FIG. 3 is a partial cross-section view of a display unit of the electrophoretic display device according to the first embodiment.

FIG. 4 is a schematic diagram showing the configuration of a microcapsule.

FIG. 5 is a flowchart showing an example of a display operation of the electrophoretic display device according to the first embodiment.

FIG. 6 is a timing chart showing an example of the display operation of the electrophoretic display device according to the first embodiment.

FIG. 7 is a table showing a combination of the first and second control electric potentials and display in a display unit, according to the first embodiment.

FIG. 8 is a table relating to partial rewriting of an image in the electrophoretic display device according to the first embodiment.

FIG. 9 is a schematic diagram schematically showing adjacent pixels of the electrophoretic display device according to the first embodiment.

FIG. 10 is a schematic diagram of a comparative example corresponding to FIG. 9.

FIG. 11 is a perspective view showing the configuration of an electronic paper sheet as an example of an electronic apparatus using the electrophoretic display device.

FIG. 12 is a perspective view showing the configuration of an electronic notebook as an example of an electronic apparatus using the electrophoretic display device.

### DESCRIPTION OF EXEMPLARY EMBODIMENTS

Hereinafter, embodiments of the invention will be described with reference to the accompanying drawings.

### First Embodiment

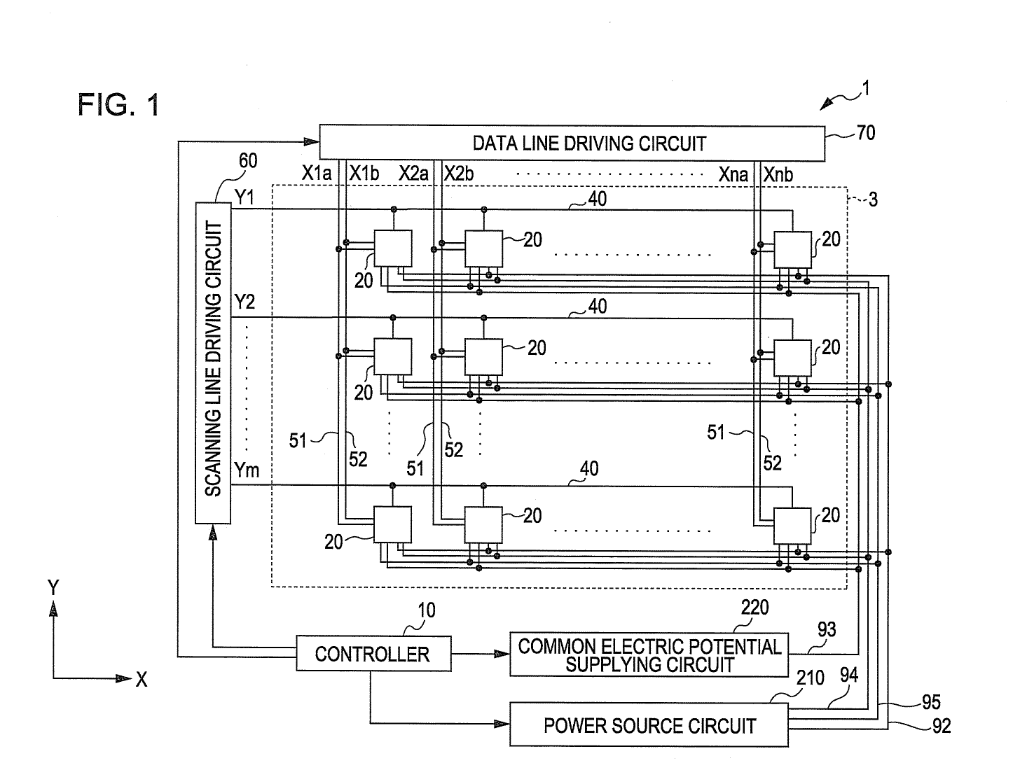

An electrophoretic display device according to a first embodiment of the invention will be described with reference to FIGS. 1 to 10.

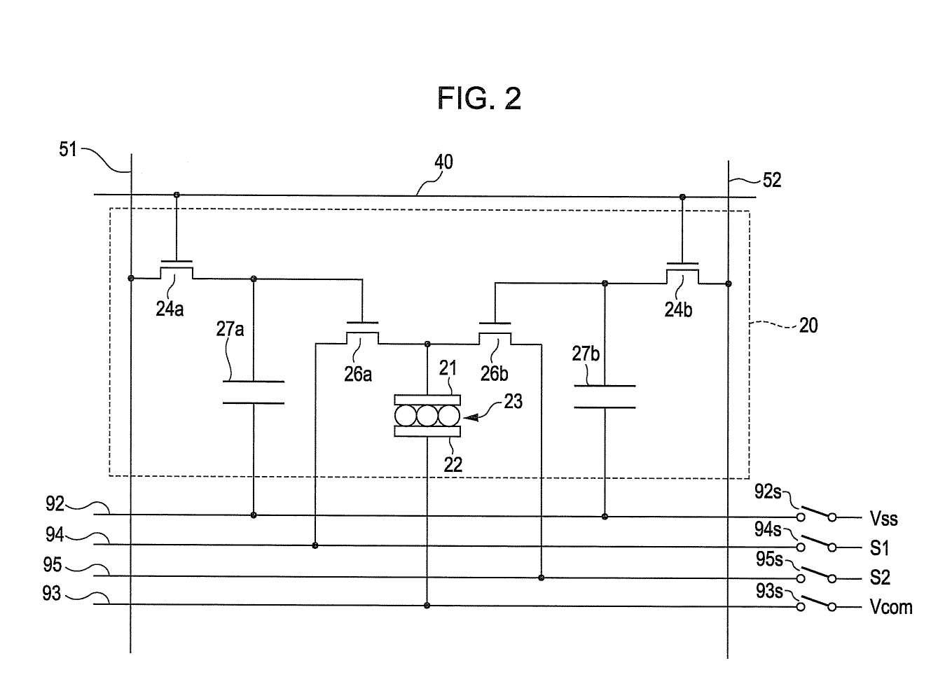

First, the entire configuration of the electrophoretic display device according to this embodiment will be described with reference to FIGS. 1 and 2.

FIG. 1 is a block diagram showing the entire configuration of the electrophoretic display device according to this embodiment.

As shown in FIG. 1, the electrophoretic display device 1 according to this embodiment includes a display unit 3, a controller 10, a scanning line driving circuit 60, a data line driving circuit 70, a power supply circuit 210, and a common electric potential supplying circuit 220.

In the display unit 3, pixels 20 of m rows×n columns are arranged in a matrix shape (in a two-dimensional plane). In addition, in the display unit 3, m scanning lines 40 (that is, scanning lines Y1, Y2, . . . , Ym) and n first data lines 51 (that is, first data lines X1a, X2a, . . . , Xna) and n second data lines 52 (that is, second data lines X1b, X2b, . . . , Xnb) are disposed to intersect each other. In particular, m scanning lines 40 extend in the row direction (that is, direction X), and n first data lines 51 and n second data lines 52 extend in the column direction (that is, direction Y). In addition, the pixels 20 are disposed in correspondence with intersections of the m scanning lines 40 and the n first data lines 51 and the n second data lines 52.

The controller 10 controls operations of the scanning line driving circuit 60, the data line driving circuit 70, the power supply circuit 210, and the common electric potential supplying circuit 220. In particular, the controller 10, for example, supplies timing signals such as a clock signal and a start pulse to each circuit. In addition, the controller 10 also controls the ON/OFF states of switches 92s, 93s, 94s, and 95s to be described later with reference to FIG. 2.

The scanning line driving circuit 60 sequentially supplies scanning signals as pulses to the scanning lines Y1, Y2, . . . , Ym based on a timing signal that is supplied from the controller 10.

The data line driving circuit 70 supplies image signals to the first data lines X1a, X2a, . . . , Xna based on a timing signal that is supplied from the controller 10. The image signals have binary levels of a high level (that is, a high electric potential level, for example, of 15 V) and a low level (that is, a low electric potential level, for example, of 0 V). In addition, the data line driving circuit 70 supplies inverted image signals to the second data lines X1b, X2b, . . . , Xnb based on a timing signal that is supplied from the controller 10. The inverted image signals are signals that are acquired by inverting the binary levels of the image signals. For example, when the image signal has the high level, the inverted image signal has the low level. On the other hand, when the image signal has the low level, the inverted image signal has the high level. In other words, the inverted image signal also has the binary level of the high level or the low level. For example, when the image signal takes the high electric potential as 15 V and takes the low electric potential as 0 V, the inverted image signal is a signal that is acquired by inverting the polarity with 7.5 V used as the reference electric potential.

The power supply circuit 210 supplies a low-potential power, supplying electric potential Vss to a low-potential power supplying line 92, it supplies a first control electric potential S1 to a first control line 94, and supplies a second control electric potential S2 to a second control line 95. Although not shown in the figure, the low-potential power supplying line 92, the first control line 94, and the second control line 95 are electrically connected to the power supply circuit 210 through electrical switches (that is, switches 92s, 94s, and 95s to be describer later with reference to FIG. 2).

The common electric potential supplying circuit 220 supplies a common electric potential Vcom to a common electric potential line 93. Although not shown in the figure, the common electric potential line 93 is electrically connected to the common electric potential supplying circuit 220 through an electrical switch (that is, a switch 93s to be described later with reference to FIG. 2).

In addition, various signals are input to or output from the controller 10, the scanning line driving circuit 60, the data line driving circuit 70, the power supply circuit 210, and the common electric potential supplying circuit 220. However, a description of signals that are not particularly related to this embodiment is omitted here.

FIG. 2 is an equivalent circuit diagram showing the electrical configuration of a pixel.

As shown in FIG. 2, the pixel 20 includes a pixel electrode 21, a common electrode 22 that is disposed so as to face the pixel electrode 21, an electrophoretic element 23 that is arranged between the pixel electrode 21 and the common electrode 22, a first selection transistor 24a, a second selection transistor 24b, a first capacitor 27a, a second capacitor 27b, a first control transistor 26a, and a second control transistor 26b. Here, the first selection transistor 24a is an example of a “first switching element” according to an embodiment of the invention, and the second selection transistor 24b is an example of a “third switching element” according to an embodiment of the invention. In addition, the first capacitor 27a is an example of a “first memory circuit” according to an embodiment of the invention, and the second capacitor 27b is an example of a “second memory circuit” according to an embodiment of the invention. The first control transistor 26a is an example of a “second switching element” according to an embodiment of the invention, and the second control transistor 26b is an example of a “fourth switching element” according to an embodiment of the invention.

The first selection transistor 24a is formed as an N-channel transistor by using amorphous semiconductor. The first selection transistor 24a has the gate electrically connected to the scanning line 40, the source electrically connected to the first data line 51, and the drain electrically connected to the first capacitor 27a. The first selection transistor 24a inputs an image signal, which is supplied from the data line driving circuit 70 (see FIG. 1) through the first data line 51, to the first capacitor 27a at a timing on the basis of a scanning signal that is supplied from the scanning line driving circuit 60 (see FIG. 1) through the scanning line 40 as a pulse. Accordingly, the image signal is written into the first capacitor 27a.

The first capacitor 27a is a capacitor element that is used for maintaining an image signal. One capacitor electrode of the first capacitor 27a is electrically connected to the drain of the first selection transistor 24a and the gate of the first control transistor 26a. In addition, the other capacitor electrode of the first capacitor 27a is electrically connected to the low-potential power supplying line 92.

The low-potential power supplying line 92 is configured such that the low-potential power supplying electric potential Vss, which is the earth electric potential (or the ground electric potential, for example, of 0 V), can be supplied from the power supply circuit 210 (see FIG. 1). The low-potential power supplying line 92 is electrically connected to the power supply circuit 210 through the switch 92s. The switch 92s is configured to be shifted between the ON and OFF states by the controller 10 (see FIG. 1). As the switch 92s is in the ON state, the low-potential power supplying line 92 and the power supply circuit 210 are electrically connected to each other. On the other hand, as the switch 92s is in the OFF state, the low-potential power supplying line 92 is in the high impedance state in which the low-potential power supplying line 92 is electrically disconnected.

The first control transistor 26a is formed as an N-channel transistor by using an amorphous semiconductor. The first control transistor 26a has the gate electrically connected to the first capacitor 27a and the drain of the first selection transistor 24a, the source electrically connected to the first control line 94, and the drain electrically connected to the pixel electrode 21. The first control transistor 26a outputs a first control electric potential S1, which is supplied from the power supply circuit 210 (see FIG. 1) through the first control line 94, to the pixel electrode 21 in accordance with the electric potential of the image signal that is maintained in the first capacitor 27a. For example, when the image signal that is maintained in the first capacitor 27a has the high level, the first control transistor 26a is in the ON state, and the first control electric potential S1 is supplied from the first control line 94 to the pixel electrode 21 through the first control transistor 26a that is in the ON state. On the other hand, when the image signal that is maintained in the first capacitor 27a has the low level, the first control transistor 26a is in the OFF state, and the first control line 94 and the pixel electrode 21 are electrically disconnected from each other by the first control transistor 26a that is in the OFF state.

The second selection transistor 24b is formed as an N-channel transistor by using an amorphous semiconductor. The second selection transistor 24b has the gate electrically connected to the scanning line 40, the source electrically connected to the second data line 52, and the drain electrically connected to the second capacitor 27b. The second selection transistor 24b inputs an inverted image signal, which is supplied from the data line driving circuit 70 (see FIG. 1) through the second data line 52, to the second capacitor 27b at a timing on the basis of a scanning signal that is supplied from the scanning line driving circuit 60 (see FIG. 1) through the scanning line 40 as a pulse. Accordingly, the image signal is written into the second capacitor 27b.

The second capacitor 27b is a capacitor element that is used for maintaining an inverted image signal. One capacitor electrode of the second capacitor 27b is electrically connected to the drain of the second selection transistor 24b and the gate of the second control transistor 26b. In addition, the other capacitor electrode of the second capacitor 27b, similarly to the other capacitor electrode of the first capacitor 27a, is electrically connected to the low-potential power supplying line 92.

The second control transistor 26b is formed as an N-channel transistor by using an amorphous semiconductor. The second control transistor 26b has the gate electrically connected to the second capacitor 27b and the drain of the second selection transistor 24b, the source electrically connected to the second control line 95, and the drain electrically connected to the pixel electrode 21. The second control transistor 24b outputs a second control electric potential S2, which is supplied from the power supply circuit 210 (see FIG. 1) through the second control line 95, to the pixel electrode 21 in accordance with the electric potential of the inverted image signal that is maintained in the second capacitor 27b. For example, when the inverted image signal that is maintained in the second capacitor 27b has the high level, the second control transistor 26b is in the ON state, and the second control electric potential S2 is supplied from the second control line 95 to the pixel electrode 21 through the second control transistor 26b that is in the ON state. On the other hand, when the inverted image signal that is maintained in the second capacitor 27b has the low level, the second control transistor 26b is in the OFF state, and the second control line 95 and the pixel electrode 21 are electrically disconnected from each other by the second control transistor 26b that is in the OFF state.

Here, particularly according to this embodiment, as described above, the first selection transistor 24a, the second selection transistor 24b, the first control transistor 26a, and the second control transistor 26b are formed as the N-channel transistors. Accordingly, it is possible to form the first selection transistor 24a, the second selection transistor 24b, the first control transistor 26a, and the second control transistor 26b by using the amorphous semiconductor in an easy manner. Therefore, the manufacturing cost of the electrophoretic display device 1 can be reduced, and the reliability of the electrophoretic display device 1 can be improved.

In this embodiment as described above, an example in which the first selection transistor 24a, the second selection transistor 24b, the first control transistor 26a, and the second control transistor 26b (hereinafter, these transistors are appropriately referred to as “transistors 24a, 24b, 26a, and 26b”) are formed as the N-channel transistors has been shown. However, as a modified example of this embodiment, the transistors 24a, 24b, 26a, and 26b may be formed as P-channel transistors. In such a case, all the transistors 24a, 24b, 26a, and 26b can be formed as the P-channel transistors in an easy manner. Therefore, the manufacturing cost of the electrophoretic display device can be reduced, and the reliability thereof can be improved.

In addition, the transistors 24a, 24b, 26a, and 26b may be formed as inorganic transistors that are formed to include an inorganic semiconductor material such as silicon or may be formed as organic transistors that are formed to include an organic semiconductor material.

When the transistors 24a, 24b, 26a, and 26b are formed as the organic transistors, as an organic semiconductor material, for example, a polymer organic semiconductor material including a fluorene-bithiophene copolymer such as poly(3-alkylthiophene), poly(3-hexylthiophen) (P3HT), poly(3-octylthiophene), poly(2,5-thienylenevinylene) (PTV), poly(para-phenylene vinylene) (PPV), poly(9,9-dioctylfluorene) (PFO), poly(9,9-dioctylfluorene-cobis-N,N′-(4-methoxyphenyl)-bis-N,N′-phenyl-1,4-phenylenediamine) (PFMO), poly(9,9-dioctylfluorene-co-benzothiadiazole) (BT), fluorene-triallylamine copolymer, triallylamine-based polymer, or poly(9,9-dioctylfluorene-co-bithiophene) (F8T2), C60, metal-phthalocyanine or their substituted derivatives, an acene molecule material such as anthracene, tetracene, pentacene, or hexacene, or low-molecular organic semiconductor including α-oligothiophenes such as quarterthiophene (4T), sexithiophene (6T), or octathiophene may be used. The above-described materials may be used as a one-type material or a mixture of two types or more.

In addition, as a method of forming the semiconductor portion of the transistors 24a, 24b, 26a, and 26b by forming a film using the organic semiconductor material, a general film-forming method such as a vapor-deposition method, a CVD method, a cast method, a pulling method, a Langmuir-Blodgett method, a spraying method, an ink jet method, or a silk screen method may be used.

As shown in FIG. 2, the first control line 94 and the second control line 95 are configured to be able to supply the first control electric potential S1 and the second control electric potential S2 from the power supply circuit 210. The first control line 94 is electrically connected to the power supply circuit 210 through the switch 94s, and the second control line 95 is electrically connected to the power supply circuit 210 through the switch 95s. The switches 94s and 95s are configured to be switched between the ON and OFF states by the controller 10. The switch 94s is in the ON state, the first control line 94 and the power supply circuit 210 are electrically connected to each other. On the other hand the switch 94s is in the OFF state, the first control line 94 is in the high impedance state in which the first control line 94 is electrically disconnected. In addition the switch 95s is in the ON state, the second control line 95 and the power supply circuit 210 are electrically connected to each other. On the other hand, as the switch 95s is in the OFF state, the second control line 95 is in the high impedance state in which the second control line 95 is electrically disconnected.

The state of the first control transistor 26a is switched between the ON state and the OFF state in accordance with the image signal that is maintained in the first capacitor 27a, and the state of the second control transistor 26b is switched between the ON and OFF states in accordance with the inverted image signal (that is, a signal acquired by inverting the binary level of the image signal) that is maintained in the second capacitor 27b. Accordingly, the ON or OFF state of the first control transistor 26a is different from that of the second control transistor 26b. In other words, when the first control transistor 26a is in the ON state, the second control transistor 26b is in the OFF state. On the other hand, when the first control transistor 26a is in the OFF state, the second control transistor 26b is in the ON state. Accordingly, each pixel electrode 21 of the plurality of pixels 20 is electrically connected to either the first control line 94 or the second control line 95 in accordance with the image signal maintained in the first capacitor 27a and the inverted image signal maintained in the second capacitor 27b. At this moment, each pixel electrode 21 of the plurality of pixels 20 is supplied with the first control electric potential S1 or the second control electric potential S2 from the power supply circuit 210 in accordance with the ON and OFF states of the switches 94s and 95s or is in the high impedance state.

Described in more detail, in a pixel 20 to which an image signal having the high level is supplied (in other words, an inverted image signal having the low level is supplied), only the first control transistor 26a between the first control transistor 26a and the second control transistor 26b is in the ON state, and the pixel electrode 21 of the pixel 20 is electrically connected to the first control line 94 and is supplied with the first control electric potential S1 from the power supply circuit 210 or is in the high impedance state, in accordance with the ON or OFF state of the switch 94s. On the other hand, in a pixel 20 to which an image signal having the low level is supplied (in other words, an inverted image signal having the high level is supplied), only the second control transistor 26b between the first control transistor 26a and the second control transistor 26b is in the ON state, and the pixel electrode 21 of the pixel 20 is electrically connected to the second control line 95 and is supplied with the second control electric potential S2 from the power supply circuit 210 or is in the high impedance state, in accordance with the ON or OFF state of the switch 95s.

The pixel electrode 21 is disposed so as to face the common electrode 22 through the electrophoretic element 23.

The common electrode 22 is electrically connected to the common electric potential line 93 to which the common electric potential Vcom is supplied. The common electric potential line 93 is configured such that the common electric potential Vcom can be supplied from the common electric potential supplying circuit 220 (see FIG. 1). The common electric potential line 93 is electrically connected to the common electric potential supplying circuit 220 through the switch 93s. The switch 93s is configured to be shifted between the ON state and the OFF state by the controller 10. The switch 93s is in the ON state, the common electric potential line 93 and the common electric potential supplying circuit 220 are electrically connected to each other. On the other hand as the switch 93s is in the OFF state, the common electric potential line 93 is in the high-impedance state in which the common electric potential line 93 is electrically disconnected.

The electrophoretic element 23 is configured by a plurality of microcapsules that is formed to include electrophoretic particles.

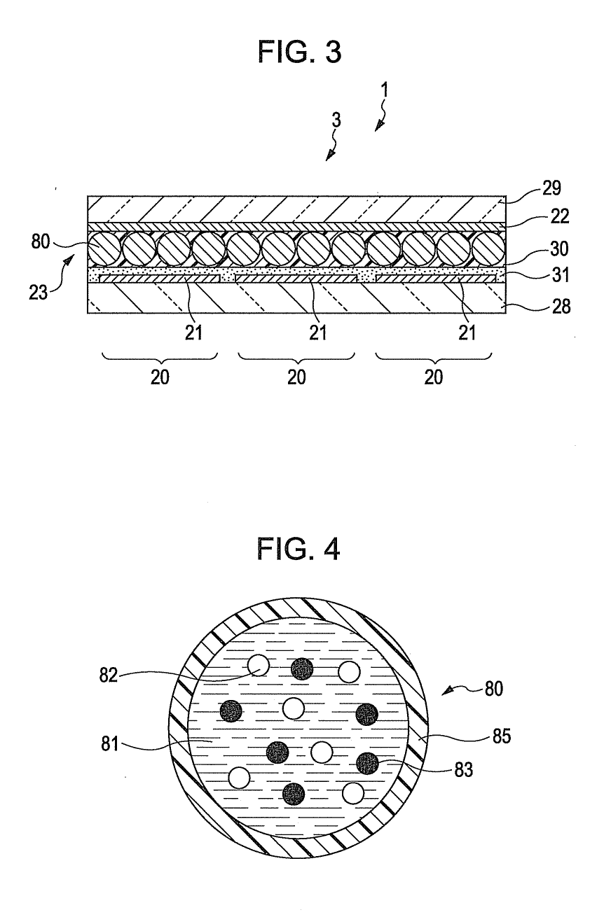

Next, a detailed configuration of the display unit of the electrophoretic display device according to this embodiment will be described with reference to FIGS. 3 and 4.

FIG. 3 is a partial cross-section view of the display unit of the electrophoretic display device according to this embodiment.

As shown in FIG. 3, the display unit 3 has a configuration in which the electrophoretic element 23 is pinched between a component substrate 28 and an opposing substrate 29. In this embodiment, descriptions will be made on a premise that an image is displayed on the opposing substrate 29 side.

The component substrate 28 is a substrate formed of glass, plastic, or the like. On the component substrate 28, although not shown in the figure, a stacked structure in which the first selection transistor 24a, the second selection transistor 24b, the first capacitor 27a, the second capacitor 27b, the first control transistor 26a, the second control transistor 26b, the scanning line 40, the first data line 51, the second data line 52, the low-potential power supplying line 92, the common electric potential line 93, the first control line 94, the second control line 95, and the like that have been described above with reference to FIG. 2 are formed, is formed. On the upper-layer side of the stacked structure, a plurality of the pixel electrodes 21 is disposed in a matrix shape.

The opposing substrate 29 is a transparent substrate, for example, formed of glass, plastic, or the like. On a face of the opposing substrate 29 which faces the component substrate 28, the common electrode 22 is formed so as to face a plurality of the pixel electrodes 21 in a spread form on the entire face. The common electrode 22 is formed of a transparent conduction material such as magnesium silver (MgAg), indium tin oxide (ITO), or indium zinc oxide (IZO).

The electrophoretic element 23 is configured by a plurality of the microcapsules 80 that is formed to include electrophoretic particles. The electrophoretic element 23 is fixed between the component substrate 28 and the opposing substrate 29 by a binder 30, for example, formed of a resin or the like and an adhesive layer 31. In the electrophoretic display device 1 according to this embodiment, in the manufacturing process, an electrophoretic sheet in which the electrophoretic element 23 is fixed to the opposing substrate 29 side by the binder 30 in advance is bonded to a side of the separately-produced component substrate 28 on which the pixel electrode 21 and the like are formed through the adhesive layer 31.

The microcapsule 80 is pinched between the pixel electrode 21 and the common electrode 22. One or a plurality of the microcapsules is disposed within one pixel 20 (that is, for one pixel electrode 21).

FIG. 4 is a schematic diagram showing the configuration of the microcapsule. In FIG. 4, the cross-section of the microcapsule is shown.

As shown in FIG. 4, the microcapsule 80 is formed by enclosing a dispersion medium 81, and a plurality of white particles 82 and a plurality of black particles 83 that are electrophoretic elements inside a coating film 85. The microcapsule 80, for example, is formed in a sphere shape having a particle diameter of about 50 μm.

The coating film 85 serves as an outer shell of the microcapsule 80 and is formed of high-molecular resin such as acryl resin including polymethylmethacrylate, polyethylmethacrylate, or the like, urea resin, gum Arabic, or the like that has transparency.

The dispersion medium 81 is a medium that disperses the white particles 82 and the black particles 83 into the inside of the microcapsule 80 (that is, the inside of the coating film 85). As the dispersion medium 81, water; an alcohol-based solvent such as methanol, ethanol, isopropanol, butanol, octanol, or methyl cellosolve; a variety of esters such as acetic ethyl or acetic butyl; ketone such as acetone, methylethylketone, or methylisobutylketone; aliphatic hydrocarbon such as pentane, hexane, or octane; cycloaliphatic hydrocarbon such as cyclohexane or methylcyclohexane; aromatic hydrocarbon such as benzene, toluene, or benzene having a long-chain alkyl group including xylene, hexylbenzene, hebuthylbenzene, octylbenzene, nonylbenzene, decylbenzene, undecylbenzene, dodecylbenzene, tridecylebenzene, or tetradecylbenzene; halogenated hydrocarbon such as methylene chloride, chloroform, carbon tetrachloride, or 1,2-dichloroethane; carboxylate; or other kinds of oils can be used in the form of a single material or a mixture. In addition, surfactant may be added to the above-described dispersion medium 81.

The white particles 82 are particles (polymer particles or colloids) made of white pigment such as titanium dioxide, zinc flower (zinc oxide), or antimony trioxide and, for example, are charged negatively.

The black particles 83 are particles (polymer particles or colloids) made of black pigment such as aniline black or carbon black and, for example, are charged positively.

Accordingly, the white particles 82 and the black particles 83 can move in the dispersion medium 81 due to an electric field that is generated by an electric potential difference between the pixel electrode 21 and the common electrode 22.

In addition, a charge control agent containing particles of an electrolyte, a surfactant, metal soap, a resin, rubber, oil, varnish, compound, or the like; a dispersant such as a titanium-coupling agent, an aluminum-coupling agent, and a silane-coupling agent; a lubricant; a stabilizing agent; or the like may be added to the above-described pigment, as is needed.

In FIGS. 3 and 4, when a voltage is applied between the pixel electrode 21 and the common electrode 22 such that the electric potential of the common electrode 22 is high relative to the pixel electrode, the positively charged black particles 83 can be attracted to the pixel electrode 21 side within the microcapsule 80 by the coulomb force, and the negatively charged white particles 82 can be attracted to the common electrode 22 side within the microcapsule 80 by the coulomb force. As a result, the white particles 82 are collected on the display face side (that is, the common electrode 22 side) of the microcapsule 80, and thereby the color (that is, the white color) of the white particles 82 can be displayed on the display face of the display unit 3. To the contrary, when a voltage is applied between the pixel electrode 21 and the common electrode 22 such that the electric potential of the pixel electrode 21 is high relative to the common electrode, the negatively charged white particles 82 can be attracted to the pixel electrode 21 side by the coulomb force, and the positively charged black particles 83 can be attracted to the common electrode 22 side by the coulomb force. As a result, the black particles 83 are collected on the display face side of the microcapsule 80, and thereby the color (that is, the black color) of the black particles 83 can be displayed on the display face of the display unit 3.

In addition, by changing the state of the distribution of the white particles 82 and the black particles 83 between the pixel electrode 21 and the common electrode 22, a gray color such as light gray, gray or dark gray that corresponds to an intermediate gray scale level between the white color and the black color can be displayed. In addition, by using pigment, for example, of a red color, a green color, a blue color, or the like instead of the pigment used for the white particles 82 or the black particles 83, color display of the red color, the green color, the blue color, or the like can be made.

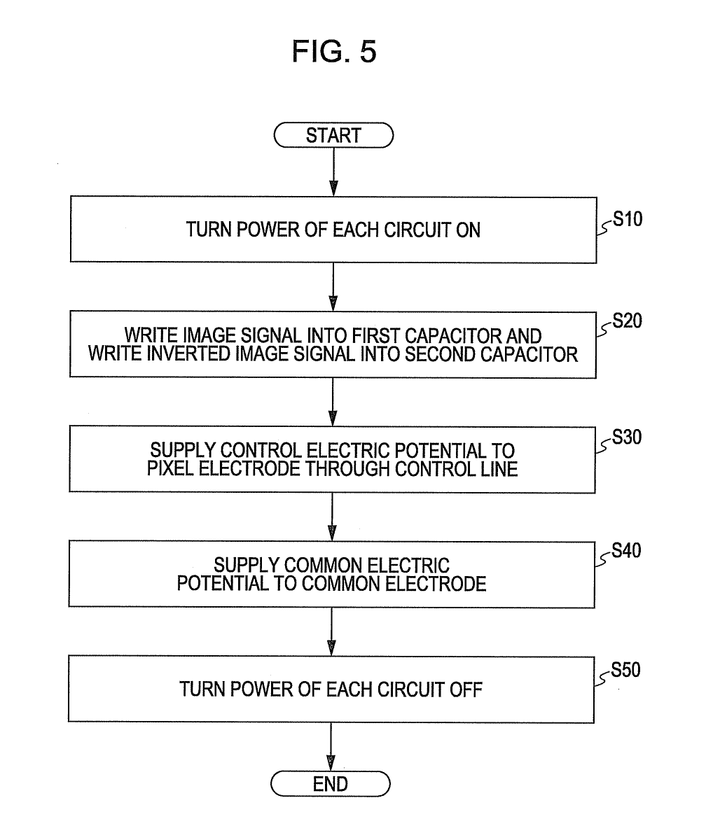

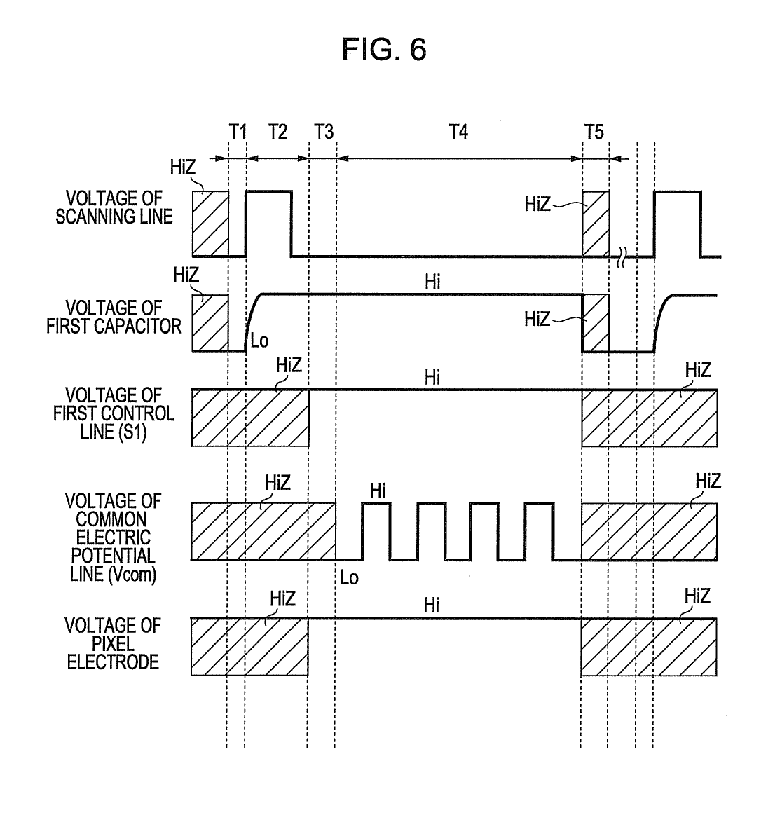

Next, an example of the display operation of the electrophoretic display device according to this embodiment will be described with reference to FIGS. 5 and 6 in addition to FIGS. 1 and 2.

FIG. 5 is a flowchart showing an example of the display operation of the electrophoretic display device according to this embodiment. FIG. 6 is a timing chart showing an example of the display operation of the electrophoretic display device according to this embodiment.

Here, as the example of the display operation, an operation for displaying an image (hereinafter, appropriately referred to as a “positive image”) desired to be displayed in the display unit 3 (see FIG. 1) will be described.

In FIGS. 5 and 6, first, the power of circuits such as the scanning line driving circuit 60, the power supply circuit 210, and the common electric potential supplying circuit 220 is turned on (Step S10). Accordingly, a low voltage (denoted by “Lo” in the figure; for example 0 V) is applied to the scanning line 40, the first capacitor 27a, and the second capacitor 27b, which have been in the high impedance state (HiZ), in a period T1. At this moment, the controller 10 allows the switch 92s to be in the ON state. In addition, the voltage of the second capacitor 27b is not shown in the figure. In addition, in the period T1, the controller 10 allows the switches 93s, 94s, and 95s to be in the OFF state, and the common electric potential line 93, the first control line 94, and the second control line 95 are in the high impedance state. In addition, the voltage of the second control line 95 is not shown in the figure.

Next, an image signal is written into the first capacitor 27a, and an inverted image signal is written into the second capacitor 27b (Step S20). In other words, in a period T2 following the period T1, scanning signals having a pulse shape are sequentially supplied to the scanning lines, Y1, Y2, . . . , Ym from the scanning line driving circuit 60. In addition, in a period in which pixels 20 located in one row corresponding to one scanning line among the scanning lines Y1, Y2, . . . , Ym are selected in accordance with the scanning signal, an image signal is supplied to a plurality of the first data lines 51 (that is, the first data lines X1a, X2a, . . . , Xna) from the data line driving circuit 70, and an inverted image signal is supplied to a plurality of the second data lines 52 (that is, the second data lines X1b, X2b, . . . , Xnb). Accordingly, in each pixel 20, the first selection transistor 24a and the second selection transistor 24b are in the ON state in accordance with the scanning signal. In addition, the image signal is written into the first capacitor 27a from the first data line 51 through the first selection transistor 24a, and the inverted image signal is written into the second capacitor 27b from the second data line 52 through the second selection transistor 24b. In FIG. 6, an example of the pixel 20 that has the first capacitor 27a in which the image signal having the high level (denoted by “Hi” in the figure; for example 15V) is written is shown, and the voltage of the first capacitor 27a that has had the low level in the period T1 has the high level in the period T2. In a pixel 20 that has the first capacitor 27a in which the image signal having the high level is written, an inverted image signal having the low level is written into the second capacitor 27b (in other words, the voltage of the second capacitor 27b has the low level). On the other hand, in a pixel 20 that has the first capacitor 27a in which the image signal having the low level is written (in other words, the voltage of the first capacitor 27a has the low level), an inverted image signal having the high level is written into the second capacitor 27b (in other words, the voltage of the second capacitor 27b has the high level).

Here, when the image signal having the high level is written into the first capacitor 27a and the inverted image signal having the low level is written into the second capacitor 27b, the first control transistor 26a is in the ON state, and the second control transistor 26b is in the OFF state, in a period in which the image signal having the high level is maintained in the first capacitor 27a (or a period in which the inverted image signal having the low level is maintained in the second capacitor 27b). On the other hand, when the image signal having the low level is written into the first capacitor 27a and the inverted image signal having the high level is written into the second capacitor 27b, the first control transistor 26a is in the OFF state, and the second control transistor 26b is in the ON state, in a period in which the image signal having the low level is maintained in the first capacitor 27a (or a period in which the inverted image signal having the high level is maintained in the second capacitor 27b).

In other words, in each pixel 20, either the first control transistor 27a or the second control transistor 27b is in the ON state in accordance with the image signal (and the inverted image signal that is maintained in the second capacitor 27b) that is maintained in the first capacitor 27a.

In addition, in the period T2, same as in the period T1, the switches 93s, 94s, and 95s are maintained to be in the OFF state by the controller 10, and the common electric potential line 93, the first control line 94, and the second control line 95 are in the high impedance state.

Next, by supplying the first control electric potential S1 and the second control electric potential S2 to the first control line 94 and the second control line 95, the first control electric potential S1 or the second control electric potential S2 is supplied to the pixel electrode 21 of each pixel 20 (Step S30). In other words, in a period T3 following the period T2, the controller 10 allows the switches 94s and 95s to be in the ON state. In addition, in the period T3, the first control electric potential S1 is supplied from the power supply circuit 210 to the first control line 94, and the second control electric potential S2 is supplied to the second control line 95. Accordingly, the first control electric potential S1 is supplied to the pixel electrode 21 of the pixel 20 having the first control transistor 27a in the ON state and the second control transistor 27b in the OFF state from the first control transistor 27a. On the other hand, the second control electric potential S2 is supplied to the pixel electrode 21 of the pixel 20 having the first control transistor 27a in the OFF state and the second control transistor 27b in the ON state from the second control transistor 27b. In FIG. 6, a case in which a constant electric potential having the high level (for example, 15 V) is supplied to the first control line 94 as the first control electric potential S1 is shown as an example. In addition, in this example, a constant low electric potential (for example, 0 V) is supplied to the second control line 95 as the second control electric potential S2. In addition, in FIG. 6, the voltage of the pixel electrode 21 of a pixel 20 having the first control transistor 27a in the ON state and the second control transistor 27b in the OFF state is shown. In the period T3, when the constant first control electric potential S1 having the high level is supplied to the first control line 94, the voltage of the pixel electrode 21 is high. In addition, the pixel electrode 21 of the pixel 20 having the first control transistor 27a in the OFF state and the second control transistor 27b in the ON state is electrically connected to the second control line 95. Accordingly, when the constant second control electric potential S2 having the low level is supplied to the second control line 95, the voltage of the pixel electrode 21 is low.

In addition, in the period T3, same as in the periods T1 and T2, the OFF state of the switch 93s that is formed by the controller 10 is maintained, and the common electric potential line 93 is in the high impedance state.

Next, the common electric potential Vcom is supplied to the common electrode 22 (Step S40). In other words, in a period T4 following the period T3, the controller 10 allows the switch 93s to be in the ON state. In addition, the high electric potential (for example, 15 V) and the low electric potential (for example, 0 V) are supplied to be repeated for each predetermined period to the common electric potential line 93 from the common electric potential supplying circuit 220 as the common electric potential Vcom. In other words, common swing driving is performed. Accordingly, in the period T4, a period in which a voltage (for example, 15 V) is applied between the pixel electrode 21 and the common electrode 22 is applied and a period in which any voltage is not applied between the pixel electrode 21 and the common electrode 22 are repeated. Here, the first control electric potential S1 (the high level, for example, of 15 V) is supplied to the pixel electrode 21 of the pixel 20 among the plurality of the pixels 20 that has the first capacitor 27a in which the image signal having the high level is maintained. On the other hand, the second control electric potential S2 (the low level, for example, of 0 V) is supplied to the pixel electrode 21 of the pixel 20 among the plurality of the pixels 20 that has the first capacitor 27a in which the image signal having the low level is maintained. Accordingly, in the pixel 20 in which the image signal having the high level is maintained in the first capacitor 27a, black display is performed based on an electric potential difference between the pixel electrode 21 to which the first control electric potential S1 (the high level, for example, of 15 V) is supplied and the common electrode 22 at the time when the common electric potential Vcom supplied from the common electric potential line 93 has the low level (for example, 0 V). On the other hand, in the pixel 20 in which the image signal having the lower level is maintained in the first capacitor 27a, white display is performed based on an electric potential difference between the pixel electrode 21 to which the second control electric potential S2 (the low level, for example, of 0 V) is supplied and the common electrode 22 at the time when the common electric potential Vcom supplied from the common electric potential line 93 has the high level (for example, 15 V). As a result, a positive image desired to be displayed in accordance with an image signal is displayed in the display unit 3.

When the positive image desired to be displayed is displayed in the display unit 3 as described above, the power of the scanning line driving circuit 60, the power supply circuit 210, the common electric-potential supplying circuit 220, and the like is turned off (Step S50). Accordingly, in a period T5 following the period T4, various wirings and elements such as the scanning line 40, the first capacitor 27a, the second capacitor 27b, the common electric potential line 93, the first control line 94, the second control line 95, and the pixel electrode 21 are in the high impedance state (HiZ). Therefore, any electric field is not generated between the pixel electrode 21 and the common electrode 22, and whereby the particles located within the microcapsule 80 do not move until a next electric field is generated. As a result, display of the positive image is maintained in the display unit 3.

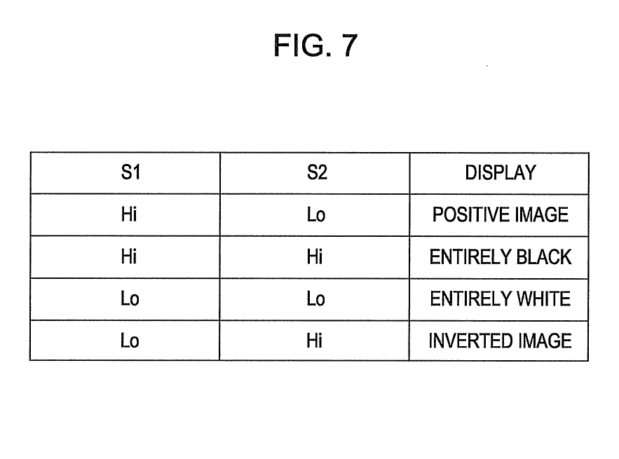

After the period T5, in order to display an image that is different from the image that is displayed in the display unit 3, then operation relating to S10 to S50 may be configured to be performed. In addition, before the positive image is displayed, a preliminary display operation to be described later with reference to FIG. 7 may be configured to be performed.

Next, the preliminary display operation of the electrophoretic display device according to this embodiment will be described with reference to FIG. 7, in addition to FIGS. 1 and 2.

FIG. 7 is a table showing the relationship between a combination of the first and second control electric potentials and display in the display unit, according to the first embodiment.

As described with reference to FIGS. 5 and 6, in the electrophoretic display device 1 according to this embodiment, the high electric potential (Hi) is supplied to the first control line 94 from the power supply circuit 210 as the first control electric potential S1, and the electric potential having the low level (Lo) is supplied to the second control line 95 as the second control electric potential S2, whereby the positive image is displayed in the display unit 3.

Here, according to the electrophoretic display device 1 of this embodiment, by controlling the first control electric potential S1 and the second control electric potential S2, a preliminary display operation (that is, for example, an operation for displaying an entirely black image, an entirely white image, an inverted image of a new image, or the like in the display unit for a short time) can be performed at the time when display is shifted from the original image to a new image. This preliminary display operation, for example, is performed after the image signal and the inverted image signal are written into the first capacitor 27a and the second capacitor 27b shown in FIG. 6 (that is, after the period T2) and before the periods T3 and T4 for displaying a new image (positive image).

As shown in FIG. 7, according to the electrophoretic display device 1 of this embodiment, after the image signal and the inverted image signal are written into the first capacitor 27a and the second capacitor 27b by performing the display operation described above with reference to FIGS. 5 and 6 (in other words, after the period T2), for example, a constant electric potential having the low level (for example, 0 V) is supplied from the common electric potential supplying circuit 220 to the common electric potential line 93 as the common electric potential Vcom, the electric potential having the high level (Hi) is supplied from the power supply circuit 210 to the first control line 94 as the first control electric potential S1, and the electric potential having the high level (Hi) is supplied to the second control line 95 as the second control electric potential S2, whereby an entirely black image can be displayed in the display unit 3. Described in more details, in a pixel 20 having the first capacitor 27a in which the image signal having the high level is maintained, the black display can be performed based on an electric potential difference between the pixel electrode 21 to which the first control electric potential S1 having the high level (for example, 15 V) is supplied and the common electrode 22 to which the common electric potential Vcom having the low level (for example, 0 V) is supplied. On the other hand, in a pixel 20 having the first capacitor 27a in which the image signal having the low level is maintained, the black display can be performed based on an electric potential difference between the pixel electrode 21 to which the second control electric potential S2 having the high level (for example, 15 V) is supplied and the common electrode 22 to which the common electric potential Vcom having the low level (for example, 0 V) is supplied.

In addition, according to the electrophoretic display device 1 of this embodiment, after the image signal and the inverted image signal are written into the first capacitor 27a and the second capacitor 27b by performing the display operation described above with reference to FIGS. 5 and 6 (in other words, after the period T2), for example, a constant electric potential having the high level (for example, 15 V) is supplied from the common electric potential supplying circuit 220 to the common electric potential line 93 as the common electric potential Vcom, the electric potential having the low level (Lo) is supplied from the power supply circuit 210 to the first control line 94 as the first control electric potential S1, and the low electric potential (Lo) is supplied to the second control line 95 as the second control electric potential S2, whereby an entirely white image can be displayed in the display unit 3. Described in more detail, in a pixel 20 having the first capacitor 27a in which the image signal having the high level is maintained, the white display can be performed based on an electric potential difference between the pixel electrode 21 to which the first control electric potential S1 having the low level (for example, 0 V) is supplied and the common electrode 22 to which the common electric potential Vcom having the high level (for example, 15 V) is supplied. On the other hand, in a pixel 20 having the first capacitor 27a in which the image signal having the low level is maintained, the white display can be performed based on an electric potential difference between the pixel electrode 21 to which the second control electric potential S2 having the low level (for example, 0 V) is supplied and the common electrode 22 to which the common electric potential Vcom having the high level (for example, 15 V) is supplied.

In addition, according to the electrophoretic display device 1 of this embodiment, after the image signal and the inverted image signal are written into the first capacitor 27a and the second capacitor 27b (in other words, after the period T2), for example, the high electric potential (for example, 15 V) and the low electric potential (for example, 0 V) are supplied so as to be repeated for each predetermined period as the common electric potential Vcom from the common electric potential supplying circuit 220 to the common electric potential line 93. In addition, by supplying the low electric potential (Lo) from the power supply circuit 210 to the first control line 94 as the first control electric potential S1 and supplying the high electric potential (Hi) to the second control line 95 as the second control electric potential S2, an inverted image (that is, an image acquired by replacing black with white and white with black in a new image (positive image) to be displayed in the periods T3 and T4) can be displayed in the display unit 3. Described in more details, in a pixel 20 having the first capacitor 27a in which the image signal having the high level is maintained, white display can be performed based on an electric potential difference between the pixel electrode 21 to which the first control electric potential S1 having the low level (for example, 0 V) is supplied and the common electrode 22 at the time when the common electric potential Vcom supplied from the common electric potential line 93 has the high level (for example, 15 V). On the other hand, in a pixel 20 having the first capacitor 27a in which the image signal having the low level is maintained, black display can be performed based on an electric potential difference between the pixel electrode 21 to which the second control electric potential S2 having the high level (for example, 15 V) is supplied and the common electrode 22 at the time when the common electric potential Vcom supplied from the common electric potential line 93 has the low level (for example, 0 V). Accordingly, the inverted image that is acquired by inverting the black and the white of the positive image can be displayed in the display unit 3. As described above, by displaying the inverted image for a positive image before the new image (the positive image) is displayed, it is difficult that an afterimage is generated in displaying the new image.

In addition, in the preliminary display operation, any one of the black display, the white display, and the inverted image display may be performed. Alternatively, two or three of the above-described three types of display may be configured to be performed continuously, or any arbitrary display may be repeatedly configured to be performed in an arbitrary order. As an example, after a preliminary display operation that is configured by the white display, the black display, and the inverted image display, the positive image is displayed.

When the period T1 shown in FIG. 6 is started, the display performed previously is maintained. Thus, by performing the above-described preliminary display operation before the new image is displayed in the periods T3 and T4 shown in FIG. 6, the white particles 82 and the black particles 83 located inside the microcapsule 80 are moved or agitated. Therefore, history on the basis of an old image can be removed (reset) from the inside of the microcapsule 80. Thereafter, when the new image is displayed in periods T3 and T4, high-quality display having a little afterimage can be performed.

As described above, according to the electrophoretic display device 1 of this embodiment, by controlling the first control electric potential S1 and the second control electric potential S2, an image relating to the preliminary display operation such as an entirely black image, an entirely white image, or an inverted image can be displayed in the display unit 3 without rewriting the image signal maintained in the first capacitor 27a and the inverted image signal maintained in the second capacitor 27b (that is, without performing supply of a scanning signal from the scanning line driving circuit 60 to the scanning line 40, supply of an image signal from the data line driving circuit 70 to the first data line 51, and supply of an inverted image signal to the second data line 52 which are needed for performing the operation relating to Step S20 described above with reference to FIG. 5, or without transferring data relating to the entirely black image, the entirely white image, or the inverted image to each pixel). Accordingly, the preliminary display operation can be performed while the power consumption being suppressed. Therefore, the power consumption can be reduced, and the afterimage can be decreased. In addition, by controlling the first control electric potential S1 and the second control electric potential S2 as described above, the entirely black image, the entirely white image, and the inverted image can be displayed in the display unit 3 without rewriting the image signal maintained in the first capacitor 27a and the inverted image signal maintained in the second capacitor 27b. Accordingly, data relating to the entirely black image, the entirely white image, or the inverted image does not need to be maintained, for example, in an external memory for performing the preliminary display operation.

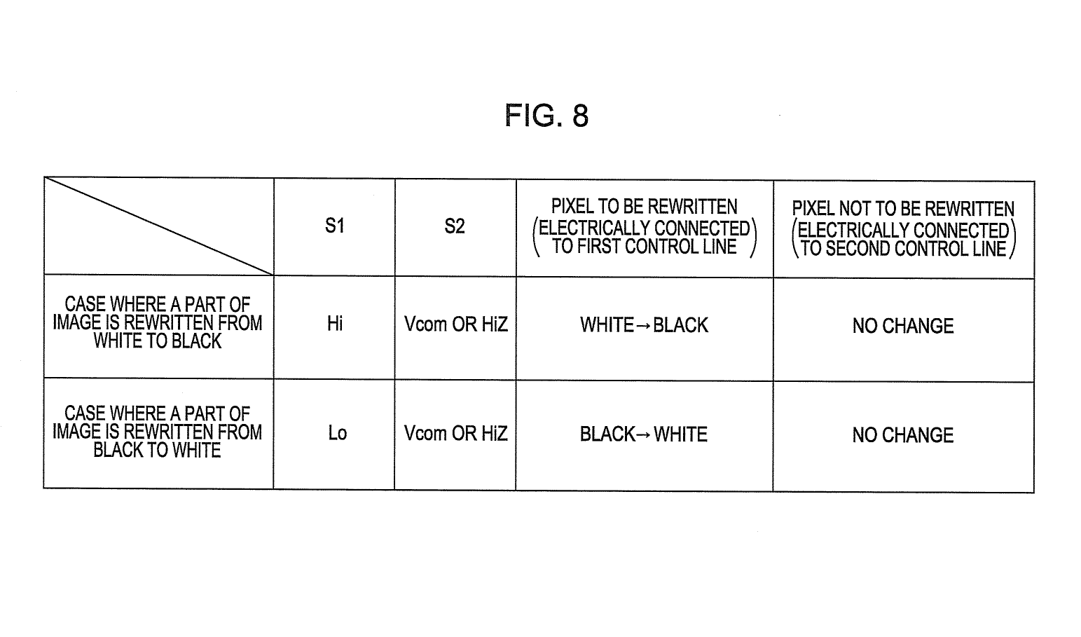

Next, partial rewriting of an image in the electrophoretic display device according to this embodiment will be described with reference to FIG. 8, in addition to FIGS. 1 and 2.

FIG. 8 is a table relating to partial rewriting of an image in the electrophoretic display device according to this embodiment.

According to the electrophoretic display device 1 of this embodiment, by supplying an image signal having the high level to each pixel in which a gray scale is to be rewritten, supplying an image signal having the low level to each pixel in which a gray scale is not to be rewritten, and controlling the first control electric potential S1 and the second control electric potential S2, a part of the original image can be rewritten, for example, from a white color to a black color (or from the black color to the white color).

Here, a case where a part of the positive image that is displayed in the display unit 3 by performing the display operation described with reference to FIGS. 5 and 6 is to be rewritten will be described as an example. In other words, the image displayed in the display unit 3 by supplying the high electric potential (Hi) from the power supply circuit 210 to the first control line 94 as the first control electric potential S1 and supplying the low electric potential (Lo) to the second control line 95 as the second control electric potential S2 will be described as the original image, a part of which is to be rewritten.

As shown in FIG. 8, according to the electrophoretic display device 1 of this embodiment, in a case where a part of the original image is rewritten from the white color to the black color, first, an image signal having the high level is written into a first capacitor 27a of each pixel of the plurality of pixels 20 in which a gray scale is to be rewritten from the white color to the black color, and an image signal having the low level is written into a first capacitor 27a of each pixel in which a gray scale is not to be rewritten. Accordingly, in the pixel in which a gray scale is to be rewritten, the pixel electrode 21 is electrically connected to the first control line 94 through the first control switch 26a that is in the ON state. On the other hand, in the pixel in which a gray scale is not to be rewritten, the pixel electrode 21 is electrically connected to the second control line 95 through the second control switch 26b that is in the ON state.

Next, the common electric potential Vcom is supplied from the common electric potential supplying circuit 220 to the common electric potential line 93. In addition, the high electric potential (Hi) is supplied from the power supply circuit 210 to the first control line 94 as the first control electric potential S1, and an electric potential that is the same as the common electric potential Vcom is supplied to the second control line 95 from the power supply circuit 210 as the second control electric potential S2 (or the second control line 95 is in the high impedance state (HiZ) by having the switch 95s to be in the OFF state by using the controller 10). Accordingly, in the pixel in which a gray scale is to be rewritten, the high electric potential is supplied to the pixel electrode 21 as the first control electric potential S1, and display is rewritten from the white color to the black color based on an electric potential difference between the pixel electrode 21 and the common electrode 22. On the other hand, in the pixel in which a gray scale is not to be rewritten, an electric potential that is the same as the common electric potential Vcom is supplied to the pixel electrode 21 as the second control electric potential S2 (or the pixel electrode 21 is in the high impedance state), and accordingly, an electric potential difference is not generated between the pixel electrode 21 and the common electrode 22, whereby display is not changed (in other words, among the pixels in which a gray scale is not to be rewritten, a pixel that has displayed the black color continues to display the black color, and a pixel that has displayed the white color continues to display the white color).

On the other hand, in a case where a part of the original image is rewritten from the black color to the white color, first, similarly to the above-described case where a part of the original image is rewritten from the white color to the black color, an image signal having the high level is written into a first capacitor 27a of each pixel of the plurality of pixels 20 in which a gray scale is to be rewritten from the black color to the white color, and an image signal having the low level is written into a first capacitor 27a of each pixel in which a gray scale is not to be rewritten. Accordingly, in the pixel in which a gray scale is to be rewritten, the pixel electrode 21 is electrically connected to the first control line 94 through the first control switch 26a that is in the ON state. On the other hand, in the pixel in which a gray scale is not to be rewritten, the pixel electrode 21 is electrically connected to the second control line 95 through the second control switch 26b that is in the ON state.

Next, the common electric potential Vcom is supplied from the common electric potential supplying circuit 220 to the common electric potential line 93. In addition, the low electric potential (Lo) is supplied from the power supply circuit 210 to the first control line 94 as the first control electric potential S1, and an electric potential that is the same as the common electric potential Vcom is supplied to the second control line 95 from the power supply circuit 210 as the second control electric potential S2 (or the second control line 95 is in the high impedance state by having the switch 95s to be in the OFF state by using the controller 10). Accordingly, in the pixel in which a gray scale is to be rewritten, the low electric potential is supplied to the pixel electrode 21 as the first control electric potential S1, and display is rewritten from the black color to the white color based on an electric potential difference between the pixel electrode 21 and the common electrode 22. On the other hand, in the pixel in which a gray scale is not to be rewritten, an electric potential that is the same as the common electric potential Vcom is supplied to the pixel electrode 21 as the second control electric potential S2 (or the pixel electrode 21 is in the high impedance state), and accordingly, an electric potential difference is not generated between the pixel electrode 21 and the common electrode 22, whereby display is not changed (in other words, among the pixels in which a gray scale is not to be rewritten, a pixel that has displayed the black color continues to display the black color, and a pixel that has displayed the white color continues to display the white color).

As described above, according to the electrophoretic display device 1 of this embodiment, by supplying an image signal having the high level to each pixel in which a gray scale is to be rewritten, supplying an image signal having the low level to each pixel in which a gray scale is not to be rewritten, and controlling the first control electric potential S1 and the second control electric potential S2, a part of the original image can be rewritten, for example, from the white color to the black color (or from the black color to the white color).

In addition, according to the electrophoretic display device 1 of this embodiment, by supplying an image signal having the low level to each pixel in which a gray scale is to be rewritten, supplying an image signal having the high level to each pixel in which a gray scale is not to be rewritten, and controlling the first control electric potential S1 and the second control electric potential S2, a part of the original image can be rewritten, for example, from the white color to the black color (or from the black color to the white color). In such a case, the common electric potential Vcom is supplied from the common electric potential supplying circuit 200 to the common electric potential line 93, an electric potential that is the same as the common electric potential Vcom is supplied to the first control line 94 from the power supply circuit 210 as the first control electric potential S1 (or the first control line 94 is in the high impedance state by having the switch 94s in the OFF state by using the controller 10), and the high electric potential (or the low electric potential) is supplied to the second control line 95 from the power supply circuit 210 as the second control electric potential S2.

According to the above-described partial rewriting of an image in the electrophoretic display device according to this embodiment, a voltage is applied between the pixel electrode 21 and the common electrode 22 of each pixel in which a gray scale is to be rewritten, and a voltage is not applied between the pixel electrode 21 and the common electrode 22 of each pixel in which a gray scale is not to be written. Accordingly, the power consumption can be reduced, and deterioration of the electrophoretic elements 23 due to application of a voltage between electrodes can be decreased.

In addition, according to the electrophoretic display device 1 of this embodiment, the above-described partial rewriting can be performed even for a case where there are two types of voltage sources having the high level and the low level. Accordingly, each circuit such as the power supply circuit 210 can be formed to have a relatively simple configuration, and therefore a practical advantage can be acquired.

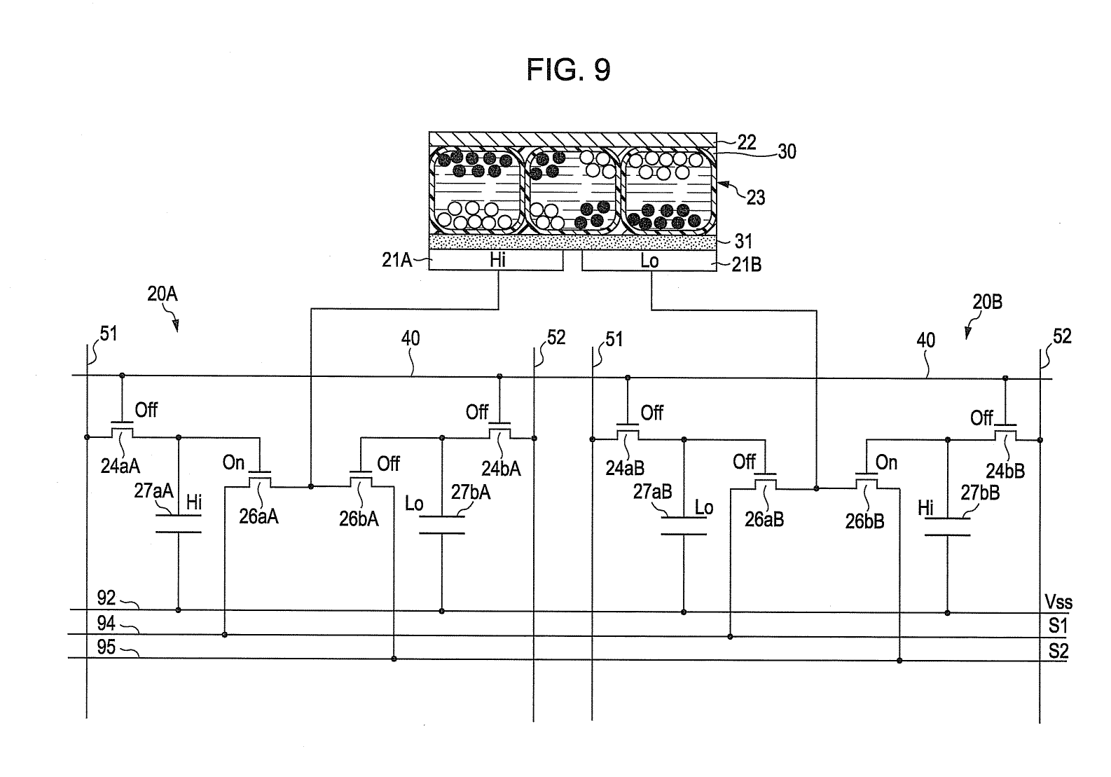

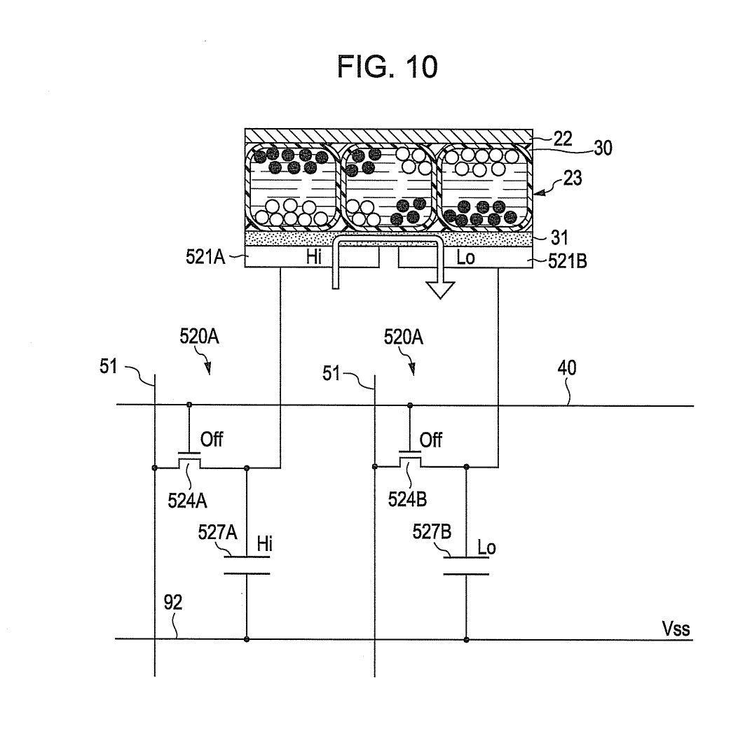

Next, the effect of a decrease in the leakage current in the electrophoretic display device according to this embodiment will be described with reference to FIGS. 9 and 10.

FIG. 9 is a schematic diagram schematically showing adjacent pixels of the electrophoretic display device according to this embodiment. FIG. 10 is a schematic diagram of a comparative example corresponding to FIG. 9.

In FIG. 9, pixels 20A and 20B of the display unit 3 that are adjacent to each other are shown. Each of the pixels 20A and 20B is configured the same as the pixel 20 described above with reference to FIG. 2. Here, subscripts “A” and “B” are attached for conveniently identifying pixels that are adjacent to each other. Similarly, the subscript “A” is attached to each constituent element of the pixel 20A, and the subscript “B” is attached to each constituent element of the pixel 20B.

As shown in FIG. 9, the pixel 20A includes a pixel electrode 21A, a first selection transistor 24aA, a second selection transistor 24bA, a first capacitor 27aA, a second capacitor 27bA, a first control transistor 26aA, and a second control transistor 26bA. In addition, the pixel 20B includes a pixel electrode 21B, a first selection transistor 24aB, a second selection transistor 24bB, a first capacitor 27aB, a second capacitor 27bB, a first control transistor 26aB, and a second control transistor 26bB.

In FIG. 9, the pixels 20 (that is, the pixels 20A and 20B) that are adjacent to each other display different colors. In other words, the pixel 20A displays the black color, and the pixel 20B displays the white color. Described in more detail, the high electric potential (Hi) is supplied as the first control electric potential S1 to the pixel electrode 21A of the pixel 20A from the first control line 95 through the first control transistor 26aA that is in the ON state (On) in accordance with an image signal having the high level (Hi) maintained in the first capacitor 27aA. In addition, the low electric potential (Lo) is supplied as the second control electric potential S2 to the pixel electrode 21B of the pixel 20B from the second control line 94 through the second control transistor 26aB that is in the ON state (On) in accordance with the high inverted image signal (Hi) maintained in the second capacitor 27bB.

Here, in the comparative example shown in FIG. 10, the pixels 520 (that is, the pixels 520A and 520B) that are adjacent to each other display different colors. The pixel 520A includes a pixel switching element 524A, a capacitor 527A, and a pixel electrode 521A. The electric potential of the pixel electrode 521A of the pixel 520A is maintained to have the high level in accordance with the high image signal (Hi) that is maintained by the capacitor 527A. The pixel 520B includes a pixel switching element 524B, a capacitor 527B, and a pixel electrode 521B. The electric potential of the pixel electrode 521B of the pixel 520B is maintained to have the low level in accordance with the low image signal (Lo) that is maintained by the capacitor 527B. At this moment, there is a problem that a leakage current of the capacitors 527A and 527B may be generated (that is, electric charges that are maintained by the capacitors 527A and 527B as the image signal or the inverted image signal may disappear) in accordance with an electric potential difference (that is, an electric potential difference between the capacitors 527A and 527B) between the adjacent pixel electrodes 521A and 521B through the adhesive layer 31, the binder 30, or the electrophoretic element 23 between the pixel electrodes 521A and 521B. In other words, according to the electrophoretic display device of the comparative example shown in FIG. 10, when different colors are displayed in the pixels 520 that are adjacent to each other, the leakage current of the capacitors 527 (that is, the capacitors 527A and 527B) may be generated between the adjacent pixels. Accordingly, an appropriate voltage is not applied between the pixel electrode 521 and the common electrode 22, and therefore the contrast may be decreased.

However, as shown in FIG. 9, according to the electrophoretic display device 1 of this embodiment, any one between the first capacitor 27a and the second capacitor 27b is electrically connected to the pixel electrode 21 (in other words, the pixel electrode 21 is electrically disconnected from the first capacitor 27a and the second capacitor 27b). Thus, even when there is an electric potential difference between the pixel electrodes 21A and 21B, a leakage current of the first capacitor 27a and the second capacitor 27b is generated scarcely or not at all. Accordingly, the number of refresh operations for supplying the image signal and the inverted image signal to the first capacitor 27a and the second capacitor 27b again can be decreased. As a result, the power consumption of the electrophoretic display device 1 is reduced. In addition, according to the electrophoretic display device 1 of this embodiment, the electric potential of the pixel electrode 21 is controlled in accordance with the first control electric potential S1 or the second control electric potential S2 applied by the power supply circuit 210 through the first control line 94 or the second control line 95. Accordingly, an appropriate voltage can be assuredly applied between the pixel electrode 521 and the common electrode 22, and thereby the contrast can be increased.

As described above in detail, according to the electrophoretic display device of this embodiment, an image having the high quality can be displayed, and the power consumption can be reduced.

### Electronic Apparatus

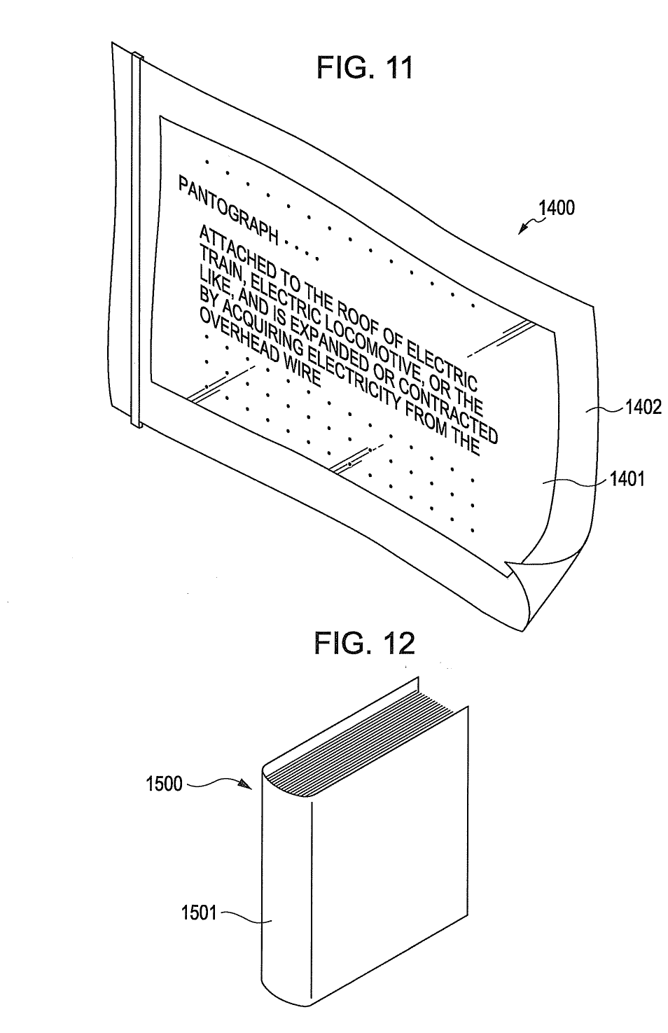

Next, an electronic apparatus that uses the above-described electrophoretic display device will be described with reference to FIGS. 11 and 12. Hereinafter, a case where the above-described electrophoretic display device is used in an electronic paper sheet and an electronic notebook will be described as examples.

FIG. 11 is a perspective view showing the configuration of the electronic paper sheet 1400.

As shown in FIG. 11, the electronic paper sheet 1400 includes the electrophoretic display device according to the above-described embodiment as a display unit 1401. The electronic paper sheet 1400 has flexibility and is configured to include a main body 1402 formed of a rewritable sheet having the same texture and flexibility as those of a general paper sheet.

FIG. 12 is a perspective view showing the configuration of the electronic notebook 1500.

As shown in FIG. 12, the electronic notebook 1500 is formed by binding a plurality of the electronic paper sheets 1400 shown in FIG. 11 so as to be inserted into a cover 1501. The cover 1501 includes a display data inputting unit (not shown) that receives display data, for example, transmitted from an external apparatus. Accordingly, the display content can be changed or updated in accordance with the display data in a state that the electronic paper sheets are bound.

According to the above-described electronic paper sheet 1400 or the electronic notebook 1500, the electrophoretic display device according to the above-described embodiment is included. Therefore, image display having the high quality can be performed with low power consumption.

In addition, the electrophoretic display device according to the above-described embodiment can be used in a display unit of an electronic apparatus such as a wrist watch, a cellular phone, or a mobile audio apparatus other than the electronic paper sheet 1400 and the electronic notebook 1500.

The invention is not limited to the above-described embodiments. Thus, the above-described embodiments may be appropriately changed within the scope not departing from the gist or the idea of the invention that is read out from the claims and descriptions here. An electrophoretic display device, a method of driving the electrophoretic display device, and an electronic apparatus having the electrophoretic display device which have such changes also belong to the technical scope of the invention.

The entire disclosure of Japanese Patent Application Nos: 2008-246569, filed Sep. 25, 2008 and 2009-117660, filed May 14, 2009 are expressly incorporated by reference herein.

What is claimed is:

1. An electrophoretic display device, comprising:
a pixel electrode;
a common electrode that faces the pixel electrode;
an electrophoretic element disposed between the pixel electrode and the common electrode;
a scanning line that supplies a scanning signal;
a first data line that supplies an image signal;
a first switching element that outputs the image signal, which is input from the first data line, in accordance with the scanning signal;
a first memory circuit that maintains the image signal output from the first switching element;
a first control line that supplies a first control electric potential;
a second switching element that outputs the first control electric potential input from the first control line to the pixel electrode in accordance with the image signal that is maintained in the first memory circuit;
a second data line that supplies an inverted image signal that is acquired by inverting the image signal with respect to a reference electric potential;
a third switching element that outputs the inverted image signal, which is input from the second data line, in accordance with the scanning signal;
a second memory circuit that maintains the inverted image signal output from the third switching element;
a second control line that supplies a second control electric potential; and
a fourth switching element that outputs the second control electric potential, which is input from the second control line, to the pixel electrode in accordance with the inverted image signal that is maintained in the second memory circuit.

2. The electrophoretic display device according to claim 1,
wherein the first switching element is configured by a first transistor that has a first input terminal that is electrically connected to the first data line, a first gate electrode that is electrically connected to the scanning line, and a first output terminal,
wherein the first memory circuit is configured to include a first capacitor element that is electrically connected to the first output terminal,
wherein the second switching element is configured by a second transistor that has a second input terminal that is electrically connected to the first control line, a second gate electrode that is electrically connected to the first output terminal and the first capacitor element, and a second output terminal that is electrically connected to the pixel electrode,
wherein the third switching element is configured by a third transistor that has a third input terminal that is electrically connected to the second data line, a third gate electrode that is electrically connected to the scanning line, and a third output terminal,
wherein the second memory circuit is configured to include a second capacitor element that is electrically connected to the third output terminal, and
wherein the fourth switching element is configured by a fourth transistor that has a fourth input terminal that is electrically connected to the second control line, a fourth gate electrode that is electrically connected to the third output terminal and the second capacitor element, and a fourth output terminal that is electrically connected to the pixel electrode.

3. The electrophoretic display device according to claim 2, wherein the first, second, third, and fourth transistors are N-channel transistors.

4. The electrophoretic display device according to claim 2, wherein the first, second, third, and fourth transistors are P-channel transistors.

5. A method of driving an electrophoretic display device, the electrophoretic display device including:
a pixel electrode;
a common electrode that faces the pixel electrode;
an electrophoretic element disposed between the pixel electrode and the common electrode;
a scanning line that supplies a scanning signal;
a first data line that supplies an image signal;
a first switching element that outputs the image signal, which is input from the first data line, in accordance with the scanning signal;
a first memory circuit that maintains the image signal output from the first switching element;
a first control line that supplies a first control electric potential;
a second switching element that outputs the first control electric potential input from the first control line to the pixel electrode in accordance with the image signal that is maintained in the first memory circuit;
a second data line that supplies an inverted image signal that is acquired by inverting the image signal with respect to a reference electric potential;
a third switching element that outputs the inverted image signal, which is input from the second data line, in accordance with the scanning signal;
a second memory circuit that maintains the inverted image signal output from the third switching element;
a second control line that supplies a second control electric potential; and
a fourth switching element that outputs the second control electric potential, which is input from the second control line, to the pixel electrode in accordance with the inverted image signal that is maintained in the second memory circuit, the method comprising:
writing the image signal from the first data line into the first memory circuit through the first switching element and writing the inverted image signal from the second data line into the second memory circuit through the third switching element; and
applying a voltage between the pixel electrode and the common electrode by supplying the first control electric potential from the first control line to the pixel electrode through the second switching element or supplying the second control electric potential from the second control line to the pixel electrode through the fourth switching element and supplying a common electric potential to the common electrode.

6. The method according to claim 5, wherein, in the applying the voltage between the pixel electrode and the common electrode, any one of a first electric potential and a second electric potential that is lower than the first electric potential is supplied as the first control electric potential to the pixel electrode through the second switching element, or any one of the first electric potential and the second electric potential is supplied as the second control electric potential to the pixel electrode through the fourth switching element, and the common electric potential is supplied such that the first electric potential and the second electric potential are repeated in each predetermined period.

7. The method according to claim 5, the electrophoretic display device further including, a display unit having a plurality of pixels,
each of the plurality of pixels having:
the pixel electrode;
the first, second, third, and fourth switching element; and
the first and second memory circuit,
the method further comprising, after the applying the voltage between the pixel electrode and the common electrode, partially rewriting an image that is displayed in the display unit by applying a voltage between the pixel electrode and the common electrode of the pixel among the plurality of pixels into which a gray scale is to be rewritten by supplying an electric potential different from the common electric potential to one of the first control line and the second control line and not applying a voltage between the pixel electrode and the common electrode of the pixel among the plurality of pixels into which a gray scale is not to be rewritten by supplying an electric potential that is the same as the common electric potential to the other of the first control line and the second control line or having the other in a high impedance state so as to be electrically disconnected.

8. An electronic apparatus comprising the electrophoretic display device according to claim 1.
